(19) United States
(12) Patent Application Publication
(10) Pub. No.: US 2005/0091001 A1
(43) Pub. Date: Apr. 28, 2005

(54) Method and instrument for evaluating supply chain performance in transport logistics

(76) Inventors: Kee-Hung Lai, Kowloon (CN); Wai-Ting Ngai, Kowloon (CN); Edwin Tai-Chiu Cheng, Kowloon (CN)

Correspondence Address: JACOBSON HOLMAN, 400 SEVENTH STREET, N.W., WASHINGTON, DC, 20004, US

(21) Appl. No.: 10/690,821

(22) Filed: Oct. 23, 2003

(51) Int. Cl. G06F 11/30

(52) U.S. Cl. 702/182

(57) ABSTRACT

This invention provides an instrument for the measurement of supply chain performance and a method for evaluating such performance. The instrument includes a plurality of items divided into three dimensions being the service effectiveness for shippers, the service effectiveness for consignees and the operations efficiency of the transport logistic providers. Use of the instrument allows a user to measure and identify areas for specific improvement in the supply chain from the perspective of the transport logistics provider.

### FIELD OF THE INVENTION

This invention relates to methods and instruments for evaluating supply chain performance in the field of transport logistics. This invention provides a specific evaluation instrument for determining the performance of the supply chain from the point of view of a transport logistics provider or consultant.

### BACKGROUND TO THE INVENTION

The emergence of the global economy and intensified competition have led many firms to recognize the importance of managing their supply chains for fast product introduction and service innovations to the markets. For improved competitiveness, many firms have embraced supply chain management (SCM) to increase organizational effectiveness and achieve such organizational goals as improved customer value, better utilization of resources, and increased profitability.

It can be appreciated that customer values and costs to customers may be critical elements to gain competitive advantages for a firm. The management of a supply chain encompasses these two elements, which together emphasize the importance of getting goods/services to customers at the right time, in the right place, under the right conditions, in the right quantities, and at the lowest possible costs. Differentiation, one type of competitive advantage for a firm, may be closely linked to the customer values of the product/service that can be delivered. Low cost, another type of competitive advantage, may be reflected in the costs of the product/service to the customers. A firm would achieve a competitive advantage by striving for excellence in both service and cost leadership. To this end, making proper performance measurement of a supply chain may be desirable as it cultivates understanding between member firms in the supply chain for performance improvement.

Traditionally, the focus of performance measurement has been on process operations within the organizational boundaries of a firm. In the context of SCM, performance measurement involves not only the internal processes, but also requires an understanding of the performance expectation of other member firms in the supply chain, backward from the suppliers and forward to the customers. Coordination between the various parties in the supply chain is key to its effective implementation.

As SCM focuses on process management beyond organizational boundaries, there is a need to measure performance for the effective management of a supply chain. It has been recognized that ‘If you cannot measure it, you cannot control it. If you cannot control it, you cannot manage it. If you cannot manage it, you cannot improve it’. In fact, the lack of relevant performance measures has been recognized as one of the major problems in process management and the management of a supply chain. Because of the different views on what should constitute supply chain performance (SCP), many firms have found it difficult to practise SCM. A major contributing factor to this problem is that, with multiple parties having different interests, it is difficult for firms to effectively evaluate the performance of their activities on a supply chain-wide basis. Consequently, firms in different parts of the supply chain tend to work to improve performance in those areas within their interest. To overcome this problem, they need a comprehensive overview of their supply chain activities and full appreciation of the impact of their performance on other member firms in the supply chain.

### OBJECT OF THE INVENTION

The object of this invention is to provide a method and a measurement instrument for SCP, with a focus on the intermediary component, i.e., transport logistics, in a supply chain process to overcome one or more difficulties of the prior art or at least provide the public with a useful choice.

### SUMMARY OF THE INVENTION

Accordingly, in a first aspect, the invention may broadly be said to consist in an instrument for evaluating supply chain performance in transport logistics including a plurality of measurement items wherein said items are divided into at least the dimension of service effectiveness for shippers, service effectiveness for consignees and operations efficiency for transport logistics providers.

Preferably said at least one of said service effectiveness for shippers and/or said service effectiveness for consignees is further sub-divided into reliability and responsiveness.

Preferably said operations efficiency is further divided into cost and asset aspects.

Accordingly, in a second aspect, the invention may broadly be said to consist in a method for evaluating supply chain performance in transport logistics comprising:
providing an instrument for evaluating supply chain performance in transport logistics including a plurality of measurement items wherein said items are divided into at least the dimension of service effectiveness for shippers, service effectiveness for consignees and operations efficiency for transport logistics providers; and
evaluating performance based on an evaluation of performance of said measurement items in said instrument.

### BRIEF DESCRIPTION OF THE DRAWINGS

Preferred embodiments of the invention will now be described with reference to the following drawings in which:

FIG. 1 shows a Supply Chain Operations Reference (SCOR) model for performance measurement in accordance with at least a first embodiment of the invention;

FIG. 2 shows a measurement instrument in accordance with an embodiment of the invention;

FIG. 3 shows the results of a pilot test of the instrument of FIG. 2;

FIG. 4 shows a table of the profiles of the respondents of the pilot test of FIG. 3;

FIG. 5 shows a table of the CFA results for an instrument in accordance with the invention from the pilot test results of FIG. 3;

FIG. 6 shows the results of discriminant validity checks using the results of FIG. 3; and

FIGS. 7 and 8 show a first order and a second order model respectively of SCP in transport logistics in accordance with an embodiment in this invention.

### DETAILED DESCRIPTION OF PREFERRED EMBODIMENTS

Transport logistics in a supply chain is usually an intermediary that facilitates the physical flows of goods from a point of origin, i.e., shipper, to a point of destination, i.e., consignee. Firms in transport logistics perform the physical distribution function to move goods from one place to another and their business processes span organizational boundaries, encompassing shippers and consignees.

Under this conception, SCP in transport logistics involves shippers on the input side and consignees on the output side. The goal of a transport logistics service provider is to satisfy the customers (both upstream and downstream) in the chain with greater effectiveness and efficiency than the competitors. The measurement of SCP in transport logistics needs to incorporate these performance aspects to be successful. For example, cost efficiency in providing the services might be an important performance measure for a transport logistics service provider. However, this might not be desired by shippers and consignees. They would instead demand high quality and low-price delivery of shipments conforming to their requirements. Another example is that delaying shipments until carriage in full truckloads is possible may reduce the costs for organizing the delivery and improve efficiency measures for the transport logistics service provider. However, this would lead to a reduction in the service effectiveness provided to shippers and consignees. Neither performance measures alone, effectiveness and efficiency, can fully reflect SCP in transport logistics.

In this regard, SCP in transport logistics should encompass not only operations efficiency parameters, but also measures of service effectiveness to meet the goals of all parties, i.e., shipper, service provider and consignee. It may not be centered only on individual functional areas, but rather on the different parties involved in the transport logistics processes and the overall SCP.

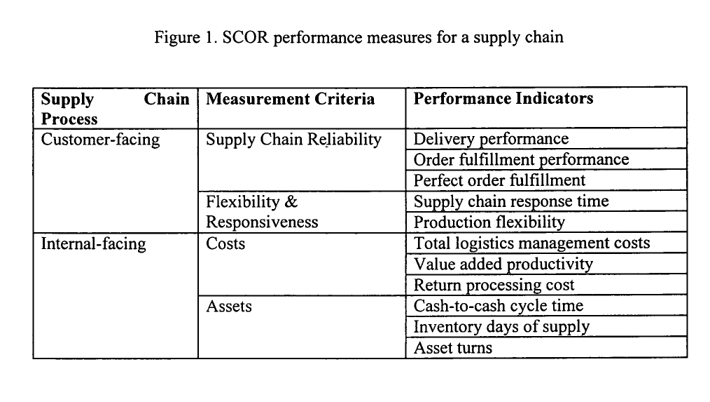

Referring to FIG. 1, a Supply Chain Operations Reference (SCOR) model as shown provides a useful framework. It represents a systematic approach to measuring performance with inputs from, and outputs to, member firms in the supply chain and considers performance assessment on a supply chain-wide basis, not just on that of an individual component, e.g. providers of transport logistics services, in the chain. This is an important point because it not only identifies both the effectiveness and efficiency aspects of performance, but also recognizes that there can be internal as well as customer-related reasons for performance measurement. Based on this, three dimensions of SCP in transport logistics may be identified. These are:
Service effectiveness for shippers (SES);
Operations efficiency for transport logistics service providers (OE);
Service effectiveness for consignees (SEC).

SES and SEC measure how well the activities are performed to meet the requirements of shippers and consignees, respectively. OE refers to the efficiency of a transport logistics service provider in the use of resources to perform its service activities. These three dimensions of SCP in transport logistics are congruent with the critical components for the supply chain success as provided in the SCOR model. In this invention, the three-factor structure of the SCP construct is tested in a first-order model, where SES, OE and SEC correlate among themselves in measuring the same construct, i.e., SCP in transport logistics, and in a second-order model, where the SCP construct is treated as a higher order model governing the covariance of the three dimensions of SES, OE and SEC.

In this preferred form of the invention, one may first define the domain of a SCP construct in transport logistics, then operationalize the construct by developing a measurement instrument. The instrument may then be pre-tested, modified, and used to capture data in a cross-sectional survey of transport logistics service providers. This method is described in the following description.

Domain Specification and Instrument Development

As stated previously, SCP in transport logistics is identified as a three-factor model. In line with SCOR, SES and SEC are customer-facing measures and concerned with the reliability (REL) and responsiveness (RES) of a supply chain process performed for shippers and consignees, respectively. These two service-oriented components may be operationalized by modifying the reliability and responsiveness dimensions of the SERVQUAL instrument developed by Parasuraman, Zeithaml and Berry (1988). The modified measures gauge the service effectiveness performed respectively for shippers (SES-REL and SES-RES) and consignees (SEC-REL and SEC-RES).

OE is concerned with the efficient use of resources in performing transport logistics services. In SCOR, there are two aspects of OE: cost-related and asset-related. The cost-related aspect of OE (OE-COST) may be operationalized by five broad categories of logistics performance: transportation, warehousing, costs associated with the facilities and manpower used in providing the services, order processing, and logistics administration. The asset-related aspect (OE-ASST) may be developed on the basis of the three measures suggested in SCOR: cash-to-cash cycle time, utilization of facilities and manpower in providing the services, and asset turns.

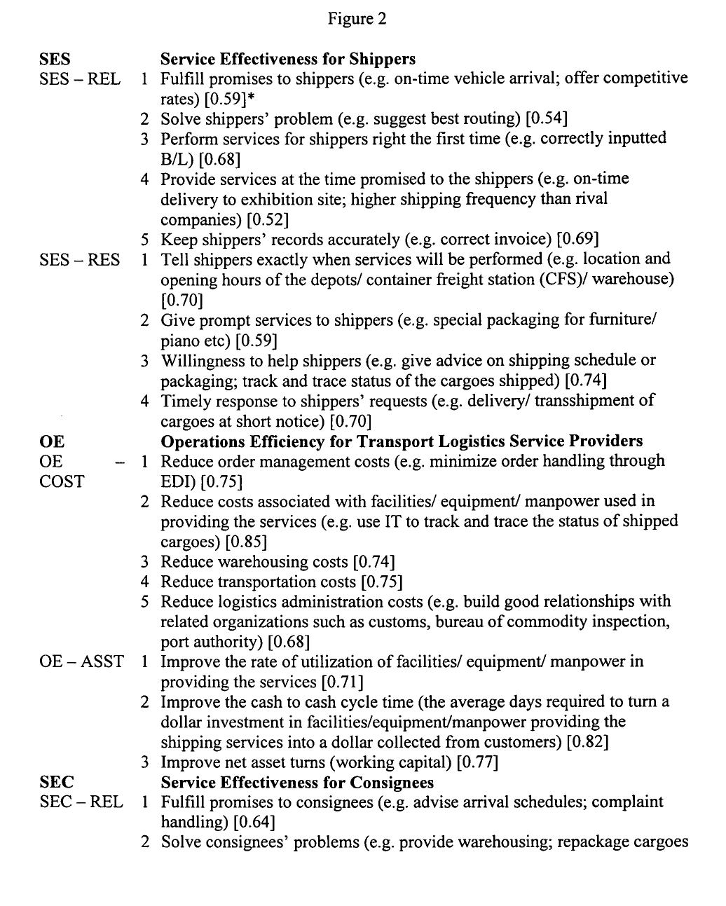

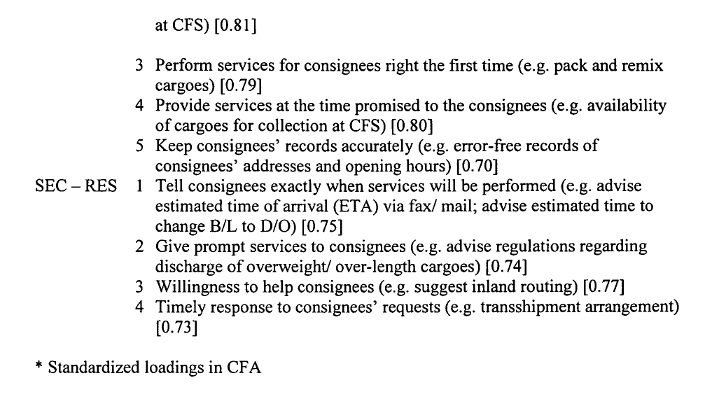

A total of 26 measurement items may then be generated for the measurement instrument: nine for SES, eight for OE and nine for SEC as shown in FIG. 2. An example is added to each item to enrich the content and improve the comprehensiveness of the item in the instrument. Content validity is concerned with the extent to which a specific set of items reflects a content domain. Assessing content validity helps to ensure that the items used to operationalize the construct actually measure what they are supposed to measure. A content validation test was preformed to ensure that they are representative of our SCP conceptualization in transport logistics. Several changes in the wording were made and the items were subject to further refinement.

Pilot Test

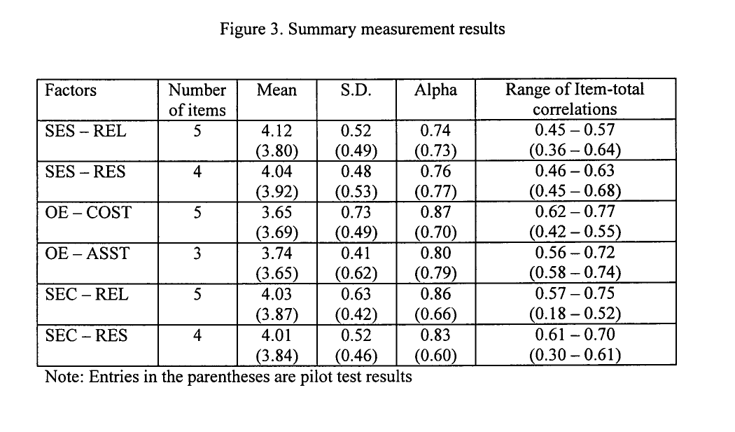

A pilot test was carried out to further test and refine the instrument. A total of 32 valid responses were collected in the pilot test. Based on the 32 responses, preliminary validity of the instrument was established on the basis of two criteria: content validity, and construct validity from an item-to-total correlation analysis and reliability test. The results of the pilot test are given in FIG. 3.

Data Collection

To further explore the SCP construct, the final version of the questionnaire was mailed, with a covering letter and a self-addressed prepaid return envelop, to a sample of 924 companies. The key informant strategy was used to carry out the survey research. Target respondents were general managers or logistics managers of the sampled companies. The questionnaire was mailed twice: one month after the first mailing, the questionnaire was again mailed to the non-respondents.

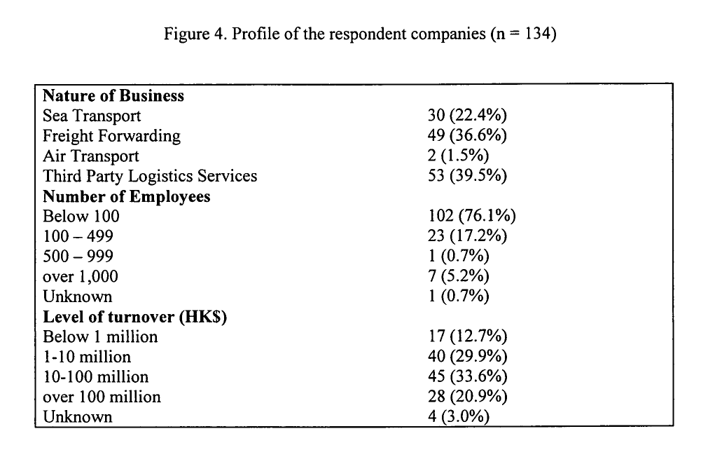

A total of 139 questionnaires were returned, but five of them were not useable because of significant data missing and incompleteness. The remaining 134 responses −97 in the first mailing and 37 in the second mailing—represent an effective response rate of 14.5%. The profiles of the respondent companies and their characteristics are displayed in FIG. 4.

A comparison of early (those responding to the first mailing) and late (those responding to the second mailing) respondents was carried out to test for non-response bias. The 26 measurement items in this study were randomly selected for a non-response bias test. The 134 survey respondents were divided into two groups based on their responses wave (first and second) and t-tests performed on the responses of the two groups. At the 5% level, there were no significant differences between the two groups in the measurement items. Although the results do not rule out the possibility of non-response bias, they suggest that non-response may not be a problem to the extent that the late respondents represent the opinions of non-respondents.

Validity and Reliability

The measurement properties of the sub-dimensions of the SCP construct were tested using reliability test and item-total correlation analysis, followed by confirmatory factor analysis (CFA). CFA was used to assess how well the observed variables, i.e., measurement items, reflect unobserved or latent variables, i.e., the sub-dimensions, in the hypothesized structure. A strong a priori basis warrants the use of CFA instead of exploratory factor analysis (EFA).

The reliability test and item-total correlation analysis results provided in FIG. 3 suggest a reasonable fit of the latent factors to the data. Cronbach alpha values for all six factors, i.e., sub-dimensions, are all greater than 0.70 and the item loadings on the factors are all acceptable, i.e., >0.40. These tests, however, do not allow for unidimensonality, convergent validity, nor discriminant validity. They were then tested using CFA.

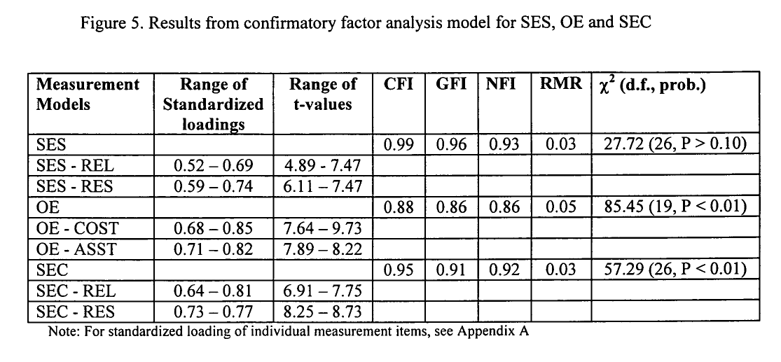

The CFA results for SES, OE, and SEC are provided in FIG. 5. A series of goodness-of-fit indices, i.e., CFI>0.90, GFI>0.90, NFI>0.90 and RMR<0.05, provide evidence of unidimensionality of the factors, though the indices for OE are marginally below the benchmark. For each of the factors, convergent validity is achieved because of the significant loading of the measurement items on their latent factors (λ>0.4 and t>2).

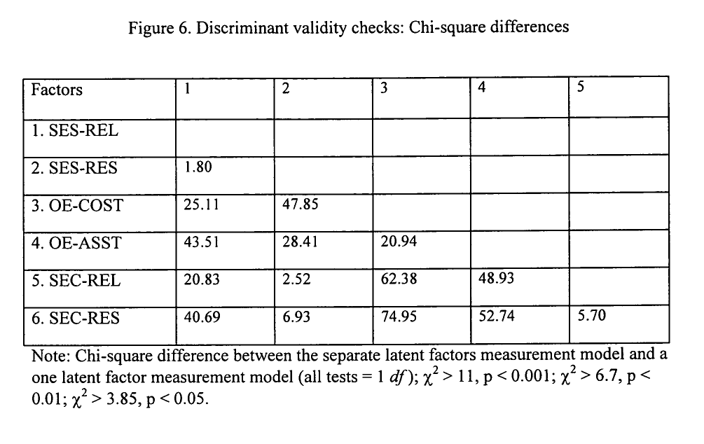

A series of pair wise CFAs were conducted to assess the discriminant validity of the sub-dimensions using chi-square difference tests. This test was performed on all possible pairs of the factors and FIG. 6 reports the results of the fifteen pair wise tests of the factors. Discriminant validity is not achieved in some cases (SES-REL and SES-RES, SEC-RES and SEC-REL). This was expected as they are the sub-dimensions of the SCP construct and are measuring a higher order latent factor, i.e., SCP in transport logistics. The significant results of the chi-square difference tests (13 out of 15) attest to the presence of discriminant validity between any two factors. Upon obtaining satisfactory reliability and validity test results, the values of the measurement items for each sub-dimension were averaged and these arithmetic means were used as single-indicator constructs to measure SCP in transport logistics in subsequent stages.

Testing First-Order and Second-Order Models

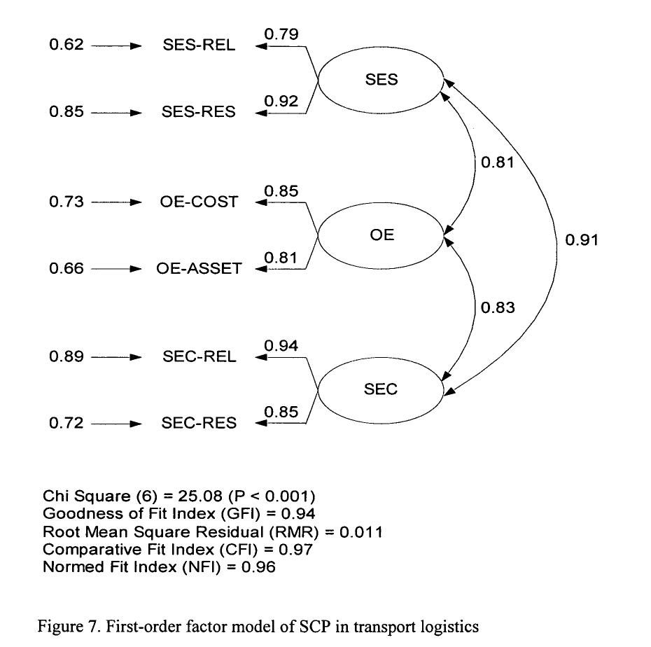

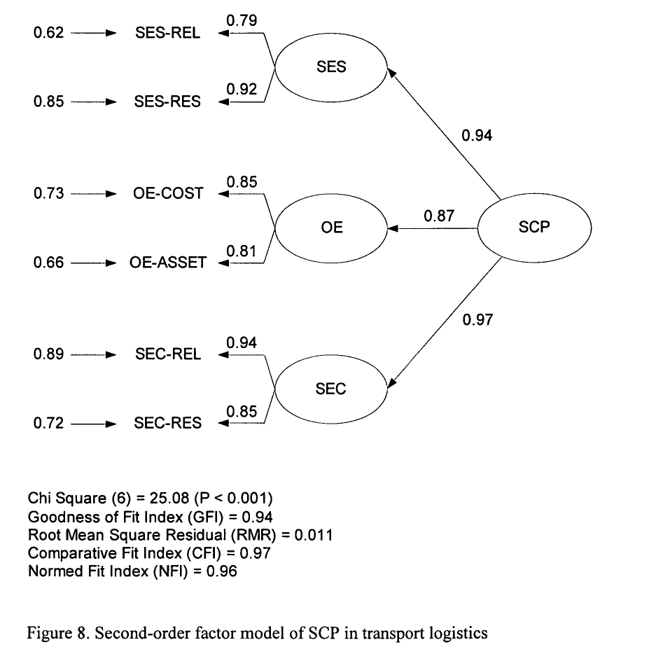

In the previous discussion, SES, OE and SEC are specified as a priori factors of SCP in transport logistics. In the first-order model, SES, OE and SEC are correlated measures for SCP in transport logistics. More preferably, SCP in transport logistics may be operationalized as a second-order model, where the three dimensions are governed by a higher order factor, i.e., SCP in transport logistics. The results of the model estimation are shown in FIGS. 7 and 8.

The first-order model for testing the existence of SCP in transport logistics implies that SES, OE and SEC are correlated but not governed by a common latent factor. Although the χ² statistic is significant (χ²=25.08; df=6; p<0.01), other fit indices suggest good fits for the first-order model. The GFI is 0.94, which is greater than 0.90 as recommended by literature suggesting an adequate model fit. The NFI and CFI are well above 0.90. Finally, the RMR is 0.011, which also suggests a good fit of the model to the data. Hence, the test results support the first-order model of SCP in transport logistics.

The test of the second-order model, illustrated in FIG. 8, implies that a higher order latent factor, i.e., the overall trait of SCP in transport logistics, governs the correlations among SES, OE and SEC. The second-order model produces a χ² statistic of 25.08 at 6 degrees of freedom with GFI, NFI and CFI well above the 0.90 benchmark and with RMR below 0.05. The second-order loadings on SCP in transport logistics are 0.94 for SES, 0.87 for OE, and 0.97 for SEC.

The efficacy of the two models were measured by comparing the χ² statistics of the first-order model and the second-order model. The fit indices of the two measurement models are the same (χ²=25.08; df=6; GFI=0.94; NFI=0.96; CFI=0.97; RMR=0.011). An examination of the second-order model of the SCP reveals that all the lambda coefficient estimates of SES and OE and SEC, which describe the relationships or paths of the three dimensions of SCP in transport logistics, are significant. The paths between SCP in transport logistics and its underlying first-order dimensions are 0.86 for SES, 0.79 for OE, and 0.80 for SEC, respectively. All the path loadings are of a high magnitude and exhibit a significantly high t-value. Therefore, SCP in transport logistics can be conceptualized as a multidimensional measure consisting of SES, OE and SEC, and the second-order model is tenable.

In this invention, a SCP construct in transport logistics is developed and the instrument measuring the construct is validated. On the basis of the SCOR model, the measurement items in the instrument are classified into three a priori dimensions of SCP in transport logistics: SES, OE, and SEC. Each dimension, in turn, consists of two sub-dimensions. The measurement instrument developed in this invention appears to adequately fit the data collected and the construct validity and reliability of the instrument are established with the systematic and scientific procedures used.

In model testing, both the first- and second-order models provide acceptable fit. In the first-order model, SES, OE and SEC are positively highly correlated measures for the SCP. The more preferable second-order model's estimated parameters are all significant, and the GFI indicates that the proposed model fits the data adequately. The unison constitutes a higher order factor that may be termed SCP in transport logistics. The implication is that firms believe that SCP in transport logistics should be multifaceted, not limited to internal processes. The existence of the second-order model suggests that SCP in transport logistics should be well-rounded, with SES, OE and SEC embedded in the measurement. In the management of transport logistics, one should strive to maintain a balanced focus on both effectiveness and efficiency aspects of performance management and improvement, aiming to meet the goals of the different parties (e.g. shippers and consignees) in the supply chain processes.

The multidimensional conceptualizations provide insights into the construct of SCP in transport logistics and its relationships with the underlying dimensions. First, the items and the sub-dimensions of the construct are specific to the transport logistics context. They provide direct and actionable information on SCP in transport logistics at item and sub-dimension levels. Second, conceptualization of the construct at higher levels, i.e., first- and second-order levels, provide users with an opportunity to look at SCP in transport logistics at a higher level of abstraction beyond the individual item and sub-dimension tiers.

At the individual item and sub-dimension levels, a user may look at the performance for each individual item and sub-dimension and may identify areas in need of special attention. For instance, if a service provider underperforms in the SES-REL item “fulfill promises to shippers”, this would signal a need for improvement actions for that particular item. On the other hand, an analysis of the construct at a higher level of abstraction offers several advantages. It may reveal patterns not readily revealed by studying individual items and sub-dimensions only. For instance, a service provider underperforms in certain SES items and outperforms in certain SEC items. If the items and sub-dimensions were not grouped according to the models as validated in this invention, users would have no clues to identify areas for improvement or formulate strategic initiatives. Performance evaluation at a higher level of abstraction may help to reveal the necessity for improvement actions in one area (e.g. SES) or prescribe a strategy for maintaining performance in another area (e.g. SEC) where the service provider may have gained a competitive edge.

It should be noted that the results could be different if the data collected and the perceptions captured are from other member firms in the supply chain, e.g. shippers and consignees. In general, shippers and consignees tend to focus more on service effectiveness, and service providers tend to be more concerned with operational efficiency. Hence testing the instrument with shippers and consignees may triangulate the findings.

This invention provides users with a comprehensive list of 26 items for measuring SCP in transport logistics, which can be used to evaluate the status of their SCP so as to uncover improvement areas. The 26 measurement items have been empirically tested to be reliable and valid in this study. The reliability coefficient (Cronbach's alpha), measured by the 26 measurement items, for the six sub-dimensions of the SCP construct are all well above 0.70. The CFA results confirm that all the 26 measurement items significantly load on their respective latent factors. The overall SCP construct also has acceptable construct validity as each of the six sub-dimensions significantly load on the construct with factor loadings of 0.79 or above in CFA. The results suggest that all the 26 measurement items are attributes of SCP in transport logistics and may form a reliable and valid measurement instrument for the construct.

A user wishing to improve SCP in transport logistics needs to constantly monitor their performance. The validated measurement instrument can be used as a self diagnostic tool to identify areas where specific improvements are needed and pinpoint aspects of the firm's SCP that require improvement actions.

A conceptual model of the relationships between SCP in transport logistics and its various organizational variables or antecedents, e.g. use of information technology, and consequences, e.g. profitability, is needed. Such models can lead to a description of what affects SCP in transport logistics and how the SCP affects the bottom-line of a firm. The instrument in this invention also provides a means for testing such relationships.

1. An instrument for evaluating supply chain performance in transport logistics including a plurality of measurement items wherein said items are divided into at least the dimension of service effectiveness for shippers, service effectiveness for consignees and operations efficiency for transport logistics providers.

2. An instrument for evaluating supply chain performance in transport logistics as claimed in claim 1 wherein at least one of said service effectiveness for shippers and/or said service effectiveness for consignees is further sub-divided into reliability and responsiveness.

3. An instrument for evaluating supply chain performance in transport logistics as claimed in claim 1 wherein said operations efficiency is further divided into cost and asset aspects.

4. An instrument for evaluating supply chain performance in transport logistics as claimed in claim 1 wherein said plurality of measured items include at least one or more items substantially related to any of the following:
Fulfill promises to shippers
Solve shippers' problem
Perform services for shippers right the first
Provide services at the time promised to the shippers
Keep shippers' records accurately
Tell shippers exactly when services will be performed
Give prompt services to shippers
Willingness to help shippers
Timely response to shippers' requests
Reduce order management costs
Reduce costs associated with facilities/equipment/manpower used in providing the services
Reduce warehousing costs
Reduce transportation costs
Reduce logistics administration costs
Improve the rate of utilization of facilities/equipment/manpower in providing the services
Improve the cash to cash cycle time
Improve net asset turns
Fulfill promises to consignees
Solve consignees' problems
Perform services for consignees right the first time
Provide services at the time promised to the consignees
Keep consignees' records accurately
Tell consignees exactly when services will be performed
Give prompt services to consignees
Willingness to help consignees
Timely response to consignees' requests

5. A method for evaluating supply chain performance in transport logistics comprising:
providing an instrument for evaluating supply chain performance in transport logistics including a plurality of measurement items wherein said items are divided into at least the dimension of service effectiveness for shippers, service effectiveness for consignees and operations efficiency for transport logistics providers; and
evaluating performance based on an evaluation of performance of said measurement items in said instrument.
